(19) United States
(12) Patent Application Publication
(10) Pub. No.: US 2021/0287154 A1
(43) Pub. Date: Sep. 16, 2021

(54) INFORMATION PROCESSING DEVICE, INFORMATION PROCESSING METHOD, AND COMPUTER PROGRAM PRODUCT

(71) Applicant: Kabushiki Kaisha Toshiba, Minato-ku (JP)

(72) Inventors: Kaneharu Nishino, Yokohama (JP); Shigeru Maya, Yokohama (JP); Ken Ueno, Tachikawa (JP)

(73) Assignee: Kabushiki Kaisha Toshiba, Minato-ku (JP)

(21) Appl. No.: 17/001,860

(22) Filed: Aug. 25, 2020

(30) Foreign Application Priority Data
Mar. 13, 2020 (JP) 2020-044661

(51) Int. Cl. G06Q 10/06

(52) U.S. Cl. CPC G06Q 10/06315; G06Q 10/0635; G06Q 10/067

(57) ABSTRACT

An information processing device includes a memory and one or more processors coupled to the memory. The one or more processors are configured to: generate a plurality of segments segmented by respective operating states of a target device based on time-series sensor data detected by a sensor that observes the target device; extract target data included in a segment having the same operating state as the operating state at certain first time out of the segments; and generate estimated data estimated to be output from the sensor at specified time different from the first time based on the target data.

### CROSS-REFERENCE TO RELATED APPLICATIONS

This application is based upon and claims the benefit of priority from Japanese Patent Application No. 2020-044661, filed on Mar. 13, 2020; the entire contents of which are incorporated herein by reference.

### FIELD

Embodiments described herein relate generally to an information processing device, an information processing method, and a computer program product.

### BACKGROUND

Parts in equipment used in social infrastructure and production sites, for example, deteriorate over operating time. To maintain performance of such equipment and prevent failures, administrators need to develop a plan of maintenance, such as replacement and repair of the parts. Carrying out maintenance with excessive frequency, however, causes disadvantageous effects, such as increased cost. For this reason, the administrators need to develop a plan to carry out maintenance at an appropriate timing.

The degree of deterioration of the equipment varies depending on operating conditions, installation environment, and other factors. As a result, equipment of the same kind does not necessarily have the same maintenance timing. To reduce downtime of the equipment and prepare parts at an appropriate timing, it is preferable that the administrators can determine the maintenance timing not after but before finding abnormalities of the equipment.

There have been developed technologies for estimating sensor data acquired from a sensor that measures equipment and estimating the state of the equipment. The use of the technologies enables estimating occurrence timings of abnormalities for respective pieces of equipment.

The states of the equipment are not uniform. The tendency in change of the state of the equipment, for example, varies depending on environment, such as temperature and humidity, and operating setting, such as the output amount and frequency. If the tendency in change of the state varies, it is difficult to accurately estimate the sensor data.

### BRIEF DESCRIPTION OF THE DRAWINGS

FIG. 1 is a diagram of a configuration of an estimation system;

FIG. 2 is a diagram of an example of sensor data;

FIG. 3 is a diagram of a functional configuration of an estimating device according to a first embodiment;

FIG. 4 is a flowchart of a procedure performed by the estimating device according to the first embodiment;

FIG. 5 is a diagram of an example of an estimation image displayed by a display device according to the first embodiment;

FIG. 6 is a diagram of a functional configuration of the estimating device according to a second embodiment;

FIG. 7 is a flowchart of a procedure performed by the estimating device according to the second embodiment;

FIG. 8 is a diagram of a functional configuration of the estimating device according to a third embodiment;

FIG. 9 is a flowchart of a procedure performed by the estimating device according to the third embodiment;

FIG. 10 is a diagram of a functional configuration of the estimating device according to a fourth embodiment;

FIG. 11 is a diagram of an example of event data;

FIG. 12 is a flowchart of a procedure performed by the estimating device according to the fourth embodiment;

FIG. 13 is a diagram of an example of the estimation image displayed by the display device according to the fourth embodiment;

FIG. 14 is a diagram of a functional configuration of the estimating device according to a fifth embodiment;

FIG. 15 is a diagram of a functional configuration of the estimating device according to a sixth embodiment;

FIG. 16 is a flowchart of a procedure performed by the estimating device according to the sixth embodiment;

FIG. 17 is a diagram of an example of the estimation image displayed by the display device according to the sixth embodiment;

FIG. 18 is a diagram of another example of the estimation image displayed by the display device according to the sixth embodiment; and

FIG. 19 is a diagram of a hardware configuration of the estimating device.

### DETAILED DESCRIPTION

According to an embodiment, an information processing device includes a memory and one or more processors coupled to the memory. The one or more processors are configured to: generate a plurality of segments segmented by respective operating states of a target device based on time-series sensor data detected by a sensor configured to observe the target device; extract target data included in a segment having a same operating state as an operating state at certain first time out of the segments; and generate estimated data estimated to be output from the sensor at specified time different from the first time based on the target data.

An estimation system 20 according to exemplary embodiments is described below with reference to the accompanying drawings. The estimation system 20 according to the embodiments accurately estimates a sensor value output at specified time from a sensor 12 that observes a target device 10.

### First Embodiment

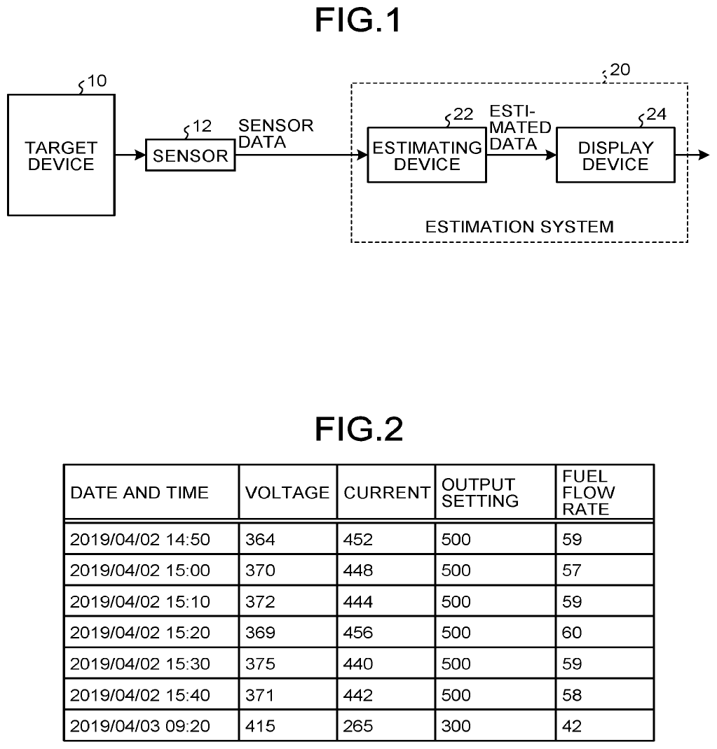

FIG. 1 is a diagram of a configuration of the estimation system 20 according to a first embodiment. The estimation system 20 includes an estimating device 22 and a display device 24.

The estimating device 22 acquires sensor data corresponding to time-series sensor values detected by the sensor 12 that observes the target device 10. Based on the acquired sensor data, the estimating device 22 generates estimated data corresponding to a sensor value obtained at specified time. Alternatively, based on the acquired sensor data, the estimating device 22 generates time-series sensor values obtained in a specified time range as estimated data.

The target device 10 is equipment used in social infrastructure and production sites, for example. The target device 10 is a fuel cell, for example. The target device 10 is not limited to equipment used in social infrastructure and production sites, for example, and may be equipment used in other scenes.

The sensor 12 observes the state of the target device 10. The sensor 12 observes environmental states, such as temperature and humidity, of the target device 10, an electric current and voltage input to or output from the target device 10, the amount of gas or fluid input to or output from the target device 10, and a set value set for the target device 10, for example.

The estimating device 22 acquires sensor data including time-series sensor values detected at predetermined time intervals. The estimating device 22 may acquire the sensor data including one sensor value at each time or the sensor data including a plurality of kinds of sensor values at each time. The estimating device 22 may acquire the sensor data including the characteristic amount of the sensor value, such as the degree of abnormality of the sensor value, observed by the sensor 12, for example.

The display device 24 displays an image including the generated estimated data on a monitor according to control by the estimating device 22.

FIG. 2 is a diagram of an example of the sensor data. If the target device 10 is a fuel cell, the estimating device 22 acquires the sensor data including the sensor values illustrated in FIG. 2, for example. More specifically, the estimating device 22 acquires the sensor data including voltage, electric current, output electric power set value, and fuel flow rate observed every ten minutes. If the target device 10 is a fuel cell, the estimating device 22 may acquire the sensor data including other sensor values besides these sensor values. The estimating device 22 may acquire the sensor data not including part of these sensor values.

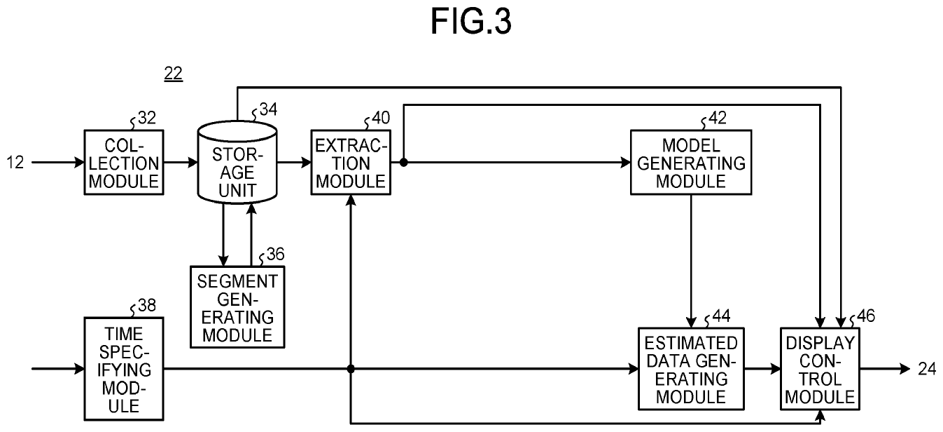

FIG. 3 is a diagram of a functional configuration of the estimating device 22 according to the first embodiment. The estimating device 22 is a single computer or a computer, such as a server device. The estimating device 22 may be one computer or a plurality of computers, such as a cloud system. The computer executes a predetermined computer program, thereby functioning as the estimating device 22.

The estimating device 22 according to the first embodiment includes a collection module 32, a storage unit 34, a segment generating module 36, a time specifying module 38, an extraction module 40, a model generating module 42, an estimated data generating module 44, and a display control module 46.

The collection module 32 collects sensor data corresponding to time-series sensor values detected by the sensor 12 that observes the target device 10. The storage unit 34 stores therein the sensor data collected by the collection module 32.

The segment generating module 36 analyzes the sensor data stored in the storage unit 34 to generate a plurality of segments that are obtained by segmenting the sensor data by respective operating states of the target device 10 in a time direction. The segment generating module 36 associates each of the segments with identification information for identifying the operating state of the segment.

The operating state of the target device 10 indicates characteristics of the sensor data obtained by analyzing the sensor data, the state of the target device 10 obtained by analyzing the sensor data, or the tendency in change of the state of the target device 10. The segment generating module 36 separates a part of the sensor data in which the same operating state continues as one segment. The segment generating module 36 associates each of the segments with the identification information for identifying the operating state of the segment.

To segment the sensor data into a plurality of segments, any desired segmentation algorithm and parameter may be used. The segment generating module 36, for example, segments the sensor data into a plurality of segments using a segmentation algorithm, such as Toeplitz Inverse Covariance-based Clustering (TICC) or Lag-Aware Multivariate Time-Series Segmentation (LAMTSS).

The segment generating module 36 stores the boundary positions of the segments and the pieces of identification information on the respective segments in the storage unit 34.

The time specifying module 38 acquires reference time. The reference time is certain time (first time) from the start of observation of the sensor values to the present time. The reference time may be the present time. The reference time may be certain time prior to the present time.

The time specifying module 38 also acquires specified time or a specified time range. The specified time and the specified time range are certain time or a time range posterior to the reference time. The specified time range may be a range from just after the reference time to after preset time, for example.

The extraction module 40 receives the reference time from the time specifying module 38 and identifies the operating state of the segment including the reference time. The extraction module 40 extracts target data including data having the same operating state as the operating state of the segment including the reference time (that is, the identified operating state) from the sensor data stored in the storage unit 34.

The target data may be all the segments of the identified operating state in the sensor data. The target data may be partial data of one or two or more segments of the identified operating state. The extraction module 40 transmits the extracted target data to the model generating module 42.

The model generating module 42 generates an estimation model based on the target data. The estimation model is a model that receives the specified time, thereby outputting the estimated data corresponding to a sensor value estimated to be output at the specified time. Alternatively, the estimation model may be a model that receives the specified time range, thereby outputting the estimated data corresponding to time-series sensor values estimated to be output in the specified time range.

The estimation model may output a confidence interval indicating the range of sensor values estimated to be output with a predetermined probability and the median of the confidence interval as the estimated data. The estimation model may output a confidence interval where the sensor value is estimated to be output with a probability of 50% and the median, for example.

The model generating module 42, for example, generates the estimation model by a statistical time-series analysis, for example. The estimation model may be an autoregressive moving average (ARMA) model, an autoregressive integrated moving average (ARIMA) model, or a seasonal autoregressive integrated moving average (SARIMA) model, for example. The model generating module 42 may generate the estimation model using a time-series estimation method by machine learning.

The model generating module 42 may generate a plurality of estimation models, evaluate performance of the estimation models, and select one estimation model having a good evaluation result. In this case, the model generating module 42 evaluates the estimation models using an information criterion, such as the Akaike information criterion (AIC) and the Bayesian information criterion (BIC). The model generating module 42 defines a part of the target data as learning data for generating the estimation model and defines the other part as evaluation data. The model generating module 42 may evaluate the estimation model based on the difference between the estimated value estimated by the estimation model and the evaluation data. The model generating module 42 may generate a plurality of estimation models and select one estimation model specified by a user out of the estimation models.

The model generating module 42 transmits the generated estimation model to the estimated data generating module 44.

The estimated data generating module 44 acquires the specified time from the time specifying module 38. The estimated data generating module 44 also acquires the estimation model from the model generating module 42. The estimated data generating module 44 inputs the specified time to the estimation model to generate the estimated data corresponding to the sensor value estimated to be output at the specified time.

The estimated data generating module 44 may acquire the specified time range from the time specifying module 38. In this case, the estimated data generating module 44 inputs the specified time range to the estimation model to generate the time-series sensor values estimated to be output in the specified time range as the estimated data. If the estimation model outputs the confidence interval and the median, the estimated data generating module 44 generates the confidence interval and the median as the estimated data.

The display control module 46 generates an estimation image including the generated estimated data. The display control module 46 transmits the estimation image to the display device 24 and displays the estimation image on the display device 24.

Furthermore, the display control module 46 may acquire the sensor data from the storage unit 34 and display the estimation image further including the sensor data on the display device 24. The display control module 46 may acquire boundary time obtained from the storage unit 34 when the sensor data is segmented into a plurality of segments in the time direction, and may display the estimation image further including the boundary time on the display device 24.

The display control module 46 may acquire a target period including the target data in the sensor data from the extraction module 40 and display the estimation image further including the target period including the target data in the sensor data on the display device 24. If the estimation model outputs the confidence interval and the median as the estimated data, the display control module 46 may display the estimation image further including the confidence interval and the median on the display device 24.

The display control module 46 may display one estimation image or a plurality of divided estimation images on the monitor.

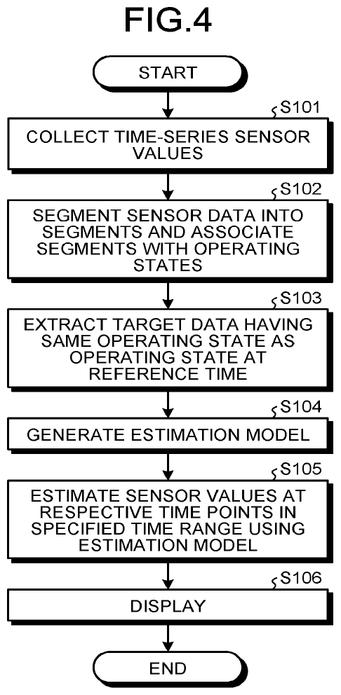

FIG. 4 is a flowchart of a procedure performed by the estimating device 22 according to the first embodiment. If the estimating device 22 according to the first embodiment receives a start instruction, the estimating device 22 performs processing by the procedure illustrated in FIG. 4.

At S101, the collection module 32 collects sensor data corresponding to time-series sensor values detected by the sensor 12 that observes the target device 10. Subsequently, at S102, the segment generating module 36 analyzes the sensor data to generate a plurality of segments that are obtained by segmenting the sensor data by the respective operating states of the target device 10 in the time direction. The segment generating module 36 associates each of the segments with identification information for identifying the operating state of the segment.

Subsequently, at S103, the extraction module 40 extracts target data having the same operating state as the operating state of the segment including the reference time from the sensor data. Subsequently, at S104, the model generating module 42 generates an estimation model based on the extracted target data.

Subsequently, at S105, the estimated data generating module 44 inputs the specified time range to the estimation model, thereby estimating the sensor values at respective time points estimated to be output in the specified time range. The estimated data generating module 44 generates the time-series sensor values to be output in the specified time range as the estimated data. If the estimation model outputs a confidence interval and the median, the estimated data generating module 44 may generate the time-series confidence intervals and medians as the estimated data.

Subsequently, at S106, the display control module 46 generates an estimation image including the generated estimated data. The display control module 46 transmits the estimation image to the display device 24 and displays the estimation image on the display device 24. After S106, the estimating device 22 ends the processing.

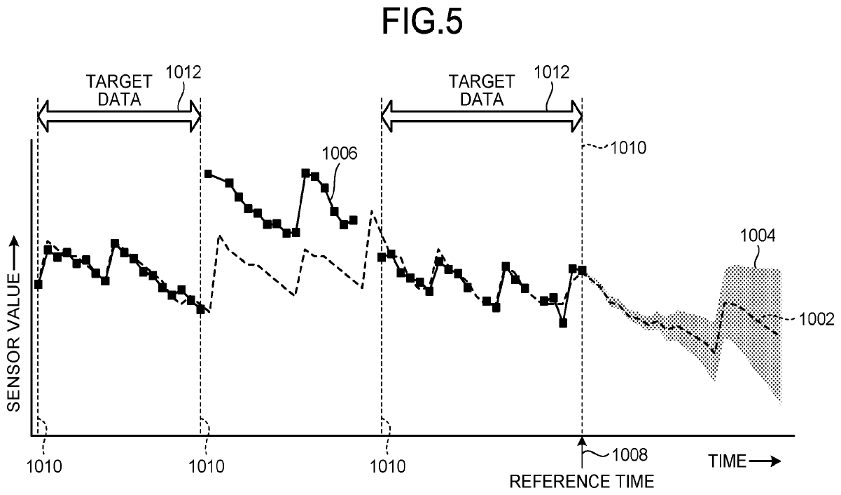

FIG. 5 is a diagram of an example of the estimation image displayed by the display device 24 according to the first embodiment. The display device 24 displays the estimation image illustrated in FIG. 5 on the monitor according to control by the display control module 46 of the estimating device 22. In the estimation image illustrated in FIG. 5, the abscissa indicates time, and the ordinate indicates sensor value.

The estimation image includes an estimated value graph 1002, a confidence interval graph 1004, an actual value graph 1006, reference time information 1008, boundary time information 1010, and target period information 1012.

The estimated value graph 1002 is a line indicating estimated data corresponding to sensor values estimated to be output from the sensor 12 that observes the target device 10 on the time axis. If the estimation model outputs the confidence interval and the median as the estimated data, the estimated value graph 1002 may be a line indicating the medians on the time axis. The confidence interval graph 1004 is an image indicating the confidence interval on the time axis. The actual value graph 1006 is a line indicating sensor data corresponding to time-series sensor values obtained by observation by the sensor 12 on the time axis.

The reference time information 1008 is information indicating the position of the reference time on the time axis. The boundary time information 1010 is information indicating the position of the boundary time of each segment on the time axis obtained when the sensor data is segmented into a plurality of segments by the respective operating states of the target device 10 in the time direction. The target period information 1012 is information indicating the target period containing the target data including data having the same operating state as the operating state of the segment including the reference time in the sensor data on the time axis.

By displaying the estimation image described above, the display device 24 according to the first embodiment can provide the user with the estimated data.

As described above, the estimation system 20 according to the first embodiment analyzes the sensor data to generate a plurality of segments that are obtained by segmenting the sensor data by the respective operating states of the target device 10 in the time direction. The estimation system 20 extracts the target data having the same operating state as the operating state of the segment including the reference time and generates the estimation model based on the target data. The estimation system 20 inputs the specified time or the specified time range to the generated estimation model to generate the estimated data. Consequently, the estimation system 20 according to the first embodiment can accurately estimate the sensor values to be output from the sensor 12 at the specified time or in the specified time range.

The tendency in change of the state of the target device 10, for example, varies depending on environment, such as temperature and humidity, and operating setting, such as the output amount and frequency. If the tendency in change of the state varies, it is difficult to accurately estimate the sensor data. If the operating setting is clear, for example, the sensor data is probably estimated by separating it for each operating setting. If there are a number of parameters not affecting the operating setting, and the correlation between the operating setting and the state of the target device 10 fails to be found, it is difficult to accurately estimate the sensor data by separating it for each operating setting. If an internal state that fails to be measured by the sensor reflects on the sensor data, for example, it is difficult to accurately estimate the sensor data by separating it for each operating setting.

To address this, the estimation system 20 according to the first embodiment analyzes the sensor data to generate the estimation model based on the target data having the same operating state as the operating state of the segment including the reference time. The estimation system 20 generates the estimated data using the generated estimation model. Consequently, the estimation system 20 according to the first embodiment can accurately estimate the sensor data if the tendency in change of the state of the target device 10 varies depending on the operating setting, such as the output amount and frequency.

### Second Embodiment

The following describes the estimation system 20 according to a second embodiment. In the description of the second embodiment and the subsequent embodiments, components having substantially the same configuration and functions as those of the components described in the previous embodiments are denoted by like reference numerals, and detailed explanation thereof is omitted except for difference.

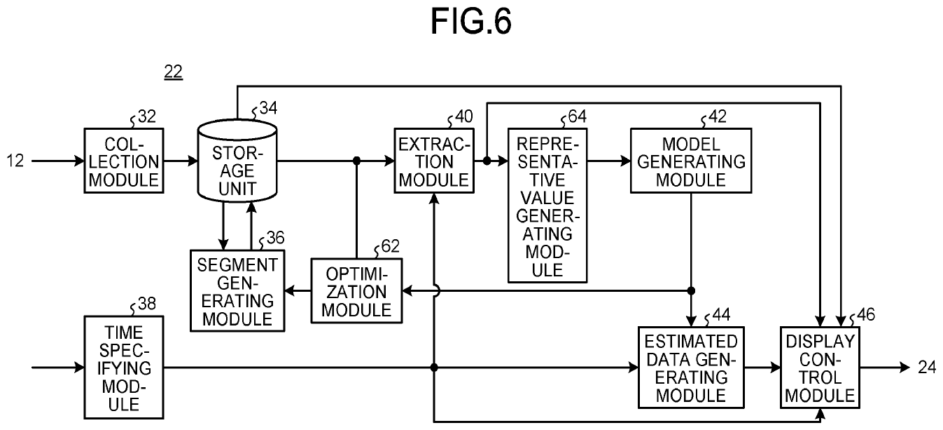

FIG. 6 is a diagram of a functional configuration of the estimating device 22 according to the second embodiment. The estimating device 22 according to the second embodiment further includes an optimization module 62 besides the components according to the first embodiment.

The optimization module 62 evaluates estimation accuracy of the estimation model generated by the model generating module 42 and optimizes the estimation model generated by the model generating module 42.

The segment generating module 36 according to the present embodiment can segment the sensor data into a plurality of segments by a plurality of methods. The segment generating module 36, for example, can segment the sensor data by a plurality of different parameters for one segmentation algorithm. Furthermore, the segment generating module 36, for example, can segment the sensor data by a plurality of segmentation algorithms.

The optimization module 62 causes the segment generating module 36 to segment the sensor data into a plurality of segments by a plurality of methods. The optimization module 62 causes the model generating module 42 to generate a plurality of estimation models using the segments resulting from segmentation by each of the methods. The optimization module 62 selects one estimation model out of the estimation models based on evaluation of the estimation accuracies of the respective estimation models and causes the estimated data generating module 44 to use the selected estimation model.

Consequently, the optimization module 62 can cause the segment generating module 36 to segment the sensor data into a plurality of segments by an appropriate segmentation algorithm or parameter so as to generate the optimum estimation model.

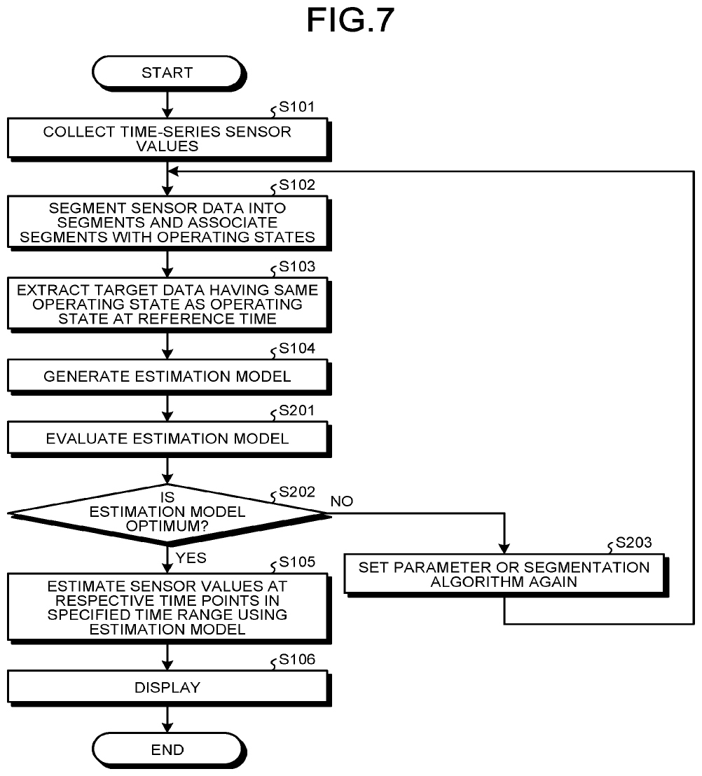

FIG. 7 is a flowchart of a procedure performed by the estimating device 22 according to the second embodiment. If the estimating device 22 according to the second embodiment receives a start instruction, the estimating device 22 performs processing by the procedure illustrated in FIG. 7. The processing performed by the estimating device 22 according to the second embodiment further includes the processing at S201, S202, and S203 compared with the first embodiment.

At S101, the collection module 32 collects sensor data corresponding to time-series sensor values detected by the sensor 12 that observes the target device 10.

Subsequently, at S102, the segment generating module 36 analyzes the sensor data to generate a plurality of segments that are obtained by segmenting the sensor data by the respective operating states of the target device 10 in the time direction. In the first loop, the segment generating module 36, for example, sets a predetermined parameter or segmentation algorithm and generates the segments by the set parameter or segmentation algorithm.

Subsequently, at S103, the extraction module 40 extracts target data having the same operating state as the operating state of the segment including the reference time from the sensor data. Subsequently, at S104, the model generating module 42 generates an estimation model based on the extracted target data.

Subsequently, at S201, the optimization module 62 evaluates the generated estimation model. The optimization module 62, for example, evaluates the estimation model using an information criterion, such as AIC and BIC. The optimization module 62, for example, defines a part of the target data as learning data for generating the estimation model and defines the other part as evaluation data. The optimization module 62 may evaluate the estimation model based on the difference between the estimated value estimated by the generated estimation model and the evaluation data.

Subsequently, at S202, the optimization module 62 determines whether it has obtained the optimum estimation model. The optimization module 62, for example, may determine a model having an evaluation value exceeding a predetermined threshold to be the optimum estimation model. The optimization module 62 may repeat the loop a predetermined number of times to generate a plurality of estimation models and select one estimation model having the highest evaluation out of the evaluation values of the respective estimation models. If the optimization module 62 has obtained the optimum estimation model (Yes at S202), the estimating device 22 performs the processing at S105. If the optimization module 62 has not obtained the optimum estimation model (No at S202), the processing proceeds to S203.

At S203, the optimization module 62 sets again the parameter or the segmentation algorithm for segmentation performed by the segment generating module 36. To set the parameter for segmentation again, for example, the optimization module 62 may change the previous parameter by adding or subtracting a predetermined value to or from the parameter. The optimization module 62 may calculate such a change direction of the parameter that the evaluation value increases using a gradient method and change the previous parameter such that the evaluation value increases. The optimization module 62 may change the value of the parameter so as to comprehensively search for a setting available range of the parameter. If the optimization module 62 finishes the processing at S203, the estimating device 22 performs the processing at S102 again.

At S105, the estimated data generating module 44 inputs the specified time range to the estimation model, thereby estimating the sensor values at respective time points estimated to be output in the specified time range. Subsequently, at S106, the display control module 46 displays an estimation image including the generated estimated data on the display device 24. After S106, the estimating device 22 ends the processing.

As described above, the estimation system 20 according to the second embodiment evaluates the estimation accuracy of the estimation model and optimizes the estimation model generated by the model generating module 42. Consequently, the estimation system 20 according to the second embodiment can more accurately estimate the sensor values to be output from the sensor 12 at the specified time or in the specified time range.

### Third Embodiment

The following describes the estimation system 20 according to a third embodiment.

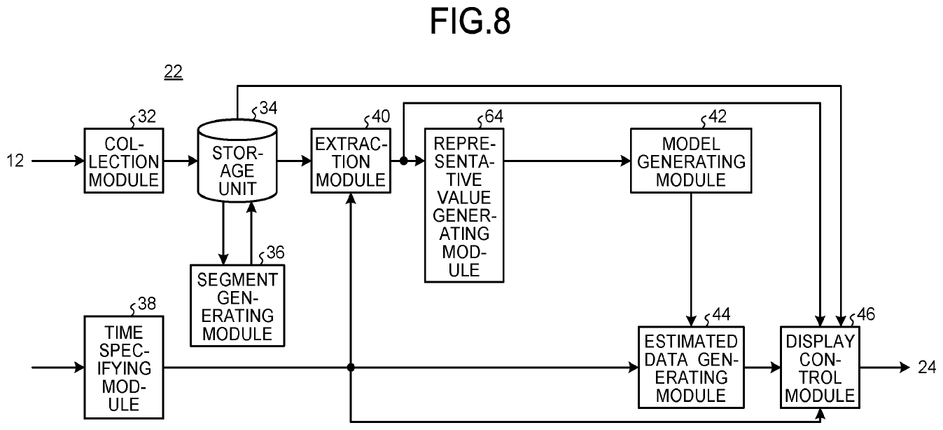

FIG. 8 is a diagram of a functional configuration of the estimating device 22 according to the third embodiment. The estimating device 22 according to the third embodiment further includes a representative value generating module 64 besides the components according to the first embodiment. Alternatively, the estimating device 22 according to the third embodiment may further include the representative value generating module 64 besides the components according to the second embodiment.

The representative value generating module 64 generates a representative value that represents a target predetermined period for each predetermined period in the target data extracted by the extraction module 40. The representative value generating module 64 generates representative value data corresponding to a set of the generated representative values. The model generating module 42 according to the third embodiment generates the estimation model based on the representative value data generated by the representative value generating module 64.

The representative value is the mean or the median of a plurality of sensor values included in the target predetermined period, for example. The predetermined period is one day (24 hours), for example. The predetermined period may be any desired period, such as one hour, six hours, 12 hours, three days, and one week. Consequently, the representative value generating module 64 can eliminate fluctuations, such as noise, of the sensor values in the predetermined period and generate an accurate estimation model based on the value from which fluctuations, such as noise, are eliminated.

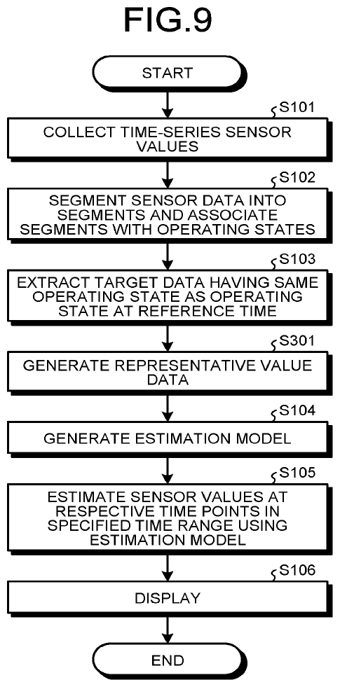

FIG. 9 is a flowchart of a procedure performed by the estimating device 22 according to the third embodiment. If the estimating device 22 according to the third embodiment receives a start instruction, the estimating device 22 performs processing by the procedure illustrated in FIG. 9.

The processing performed by the estimating device 22 according to the third embodiment further includes the processing at S301 compared with the first embodiment. The following describes differences from the first embodiment with reference to the procedure illustrated in FIG. 9.

Subsequently to the processing at S103, the estimating device 22 performs the processing at S301. At S301, the representative value generating module 64 generates a representative value that represents a target predetermined period for each predetermined period in the extracted target data. The representative value generating module 64 generates representative value data corresponding to a set of the generated representative values.

Subsequently to the processing at S301, the estimating device 22 performs the processing at S104. At S104, the model generating module 42 generates an estimation model based on the generated representative value data.

As described above, the estimation system 20 according to the third embodiment generates the representative value data corresponding to a set of the representative values for each predetermined period in the target data and generates the estimation model based on the representative value data. Consequently, the estimation system 20 according to the third embodiment can more accurately estimate the sensor values using the estimation model generated based on the data from which noise or the like is eliminated.

### Fourth Embodiment

The following describes the estimation system 20 according to a fourth embodiment.

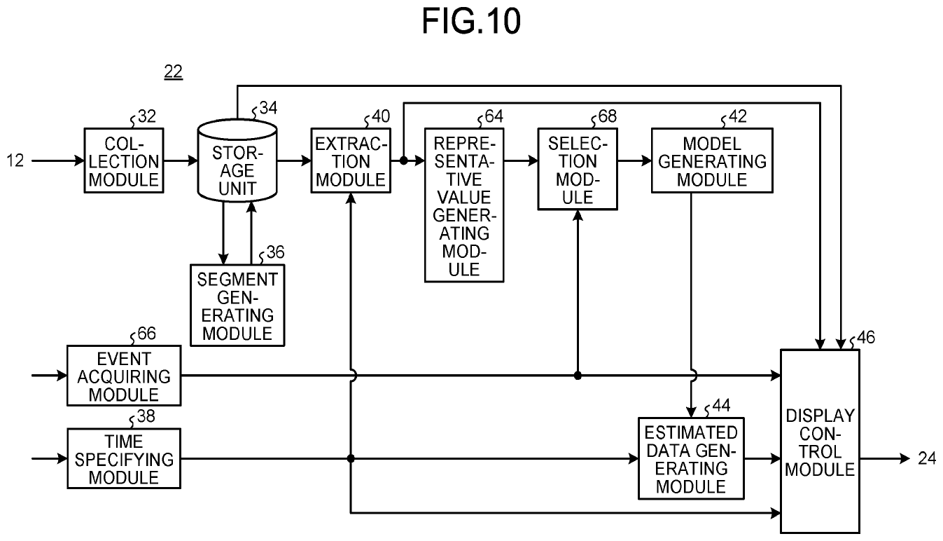

FIG. 10 is a diagram of a functional configuration of the estimating device 22 according to the fourth embodiment. The estimating device 22 according to the fourth embodiment further includes an event acquiring module 66 and a selection module 68 besides the components according to the third embodiment. Alternatively, the estimating device 22 according to the fourth embodiment may further include the event acquiring module 66 and the selection module 68 besides the components according to the first or the second embodiment.

The event acquiring module 66 acquires event data indicating information on an event occurring for the target device 10. The event data includes occurrence time and a duration time of the event, for example. The event acquiring module 66 may acquire time-series event data.

The event acquiring module 66 may acquire event data indicating information on a plurality of kinds of events. In this case, the event data further includes information for identifying the kind of the events. If the occurring events are different in size, the event data may also include information indicating the size of the events.

The event acquiring module 66 may acquire event data including information on an event to occur after the present time. The event acquiring module 66 transmits the acquired event data to the selection module 68.

Based on the acquired event data, the selection module 68 removes or selects data in a period determined based on occurrence of the event from the target data extracted by the extraction module 40. The selection module 68 may remove or select data in a period determined based on the occurrence time of the event from the representative value data generated by the representative value generating module 64.

The selection module 68, for example, may remove data in the period determined based on occurrence of the event from the target data. By contrast, the selection module 68 may select data in the period determined based on the event and remove data in other periods.

Examples of the period determined based on occurrence of the event include, but are not limited to, a period in which the event continues, a certain period before the time at which the event occurs, a certain period after the time at which the event occurs, a certain period before and after the time at which the event occurs, etc.

Based on a plurality of sensor values included in the period determined based on occurrence of the event, the selection module 68, for example, calculates an expected value or a standard deviation of the sensor values from the target data. The selection module 68 may identify an expectation range of the sensor values based on the calculated expected value and standard deviation and remove or select data having the sensor values deviated from the expectation range from the target data.

The model generating module 42 according to the present embodiment acquires, from the selection module 68, the target data or the representative value data from which the data in the period determined based on occurrence of the event is removed or selected. The model generating module 42 generates the estimation model based on the acquired target data or representative value data.

The model generating module 42 may further receive the event data and generate the estimation model that outputs the estimated data. In this case, the estimation model generates the estimated data by receiving at least one of the kind, the occurrence time, the duration time, and the size of the event indicated by the event data besides the specified time or the specified time range.

If the model generating module 42 generates a plurality of estimation models and selects an estimation model having a good evaluation result, the generated estimation models may include estimation models that further receive the event data and estimation models that do not receive the event data.

If the estimation model further receives the event data and outputs the estimated data, the estimated data generating module 44 acquires the event data from the event acquiring module 66. In this case, the estimated data generating module 44 inputs the event data to the estimation model to generate the estimated data. The estimated data generating module 44 may input the event data relating to an event to occur after the present time to the estimation model to generate the estimated data.

The display control module 46 further acquires the event data from the event acquiring module 66. Based on the event data, the display control module 46 displays the estimation image further including the occurrence time of the event and the kind of the occurring event, for example, on the display device 24.

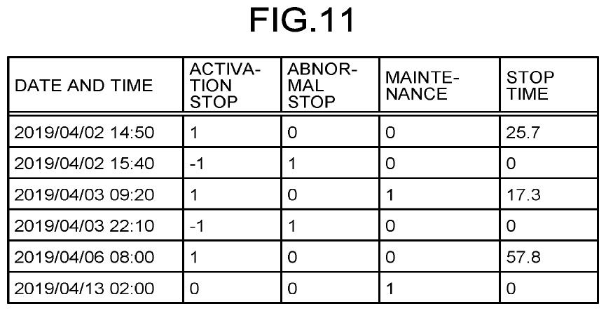

FIG. 11 is a diagram of an example of the event data. If the target device 10 is a fuel cell, the estimating device 22 may acquire the event data displayed in time series as illustrated in FIG. 11, for example. The estimating device 22 may acquire the event data indicating occurrence time of the event, information indicating whether an activation stop event occurs, information indicating whether an abnormal stop event occurs, information indicating whether stop due to maintenance occurs, and stop time, for example.

The estimating device 22, for example, may acquire the event data indicating that a measured value detected by a measuring device, being different from the sensor 12 and measuring the state of the target device 10, falls out of a predetermined value range. If the target device 10 is a fuel cell, for example, the measured value detected by the measuring device different from the sensor 12 may be a voltage value or a current value output from the fuel cell.

In this case, the selection module 68, for example, removes data in the period when the measured value falls out of the predetermined value range from the target data or the representative value data. The selection module 68, for example, removes data in the period when the current value output from the fuel cell falls out of the predetermined value range from the target data or the representative value data. As a result, the model generating module 42 can generate the estimation model based on target data or representative value data obtained by removing the data in the period when a normal operation is not performed.

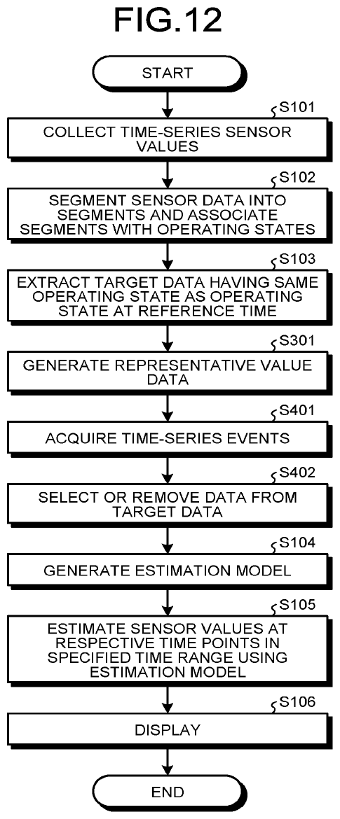

FIG. 12 is a flowchart of a procedure performed by the estimating device 22 according to the fourth embodiment. If the estimating device 22 according to the fourth embodiment receives a start instruction, the estimating device 22 performs processing by the procedure illustrated in FIG. 12.

The processing performed by the estimating device 22 according to the fourth embodiment further includes the processing at S401 and S402 compared with the third embodiment. The following describes differences from the third embodiment with reference to the procedure illustrated in FIG. 12.

Subsequently to the processing at S301, the estimating device 22 performs the processing at S401. At S401, the event acquiring module 66 acquires event data indicating information on an event occurring for the target device 10. Subsequently, at S402, the selection module 68 removes or selects data in a period determined based on occurrence of the event from the representative value data based on the acquired event data.

Subsequently to S402, the estimating device 22 performs the processing at S104. At S104, the model generating module 42 generates an estimation model based on the representative value data from which the data determined based on occurrence of the event is removed or selected.

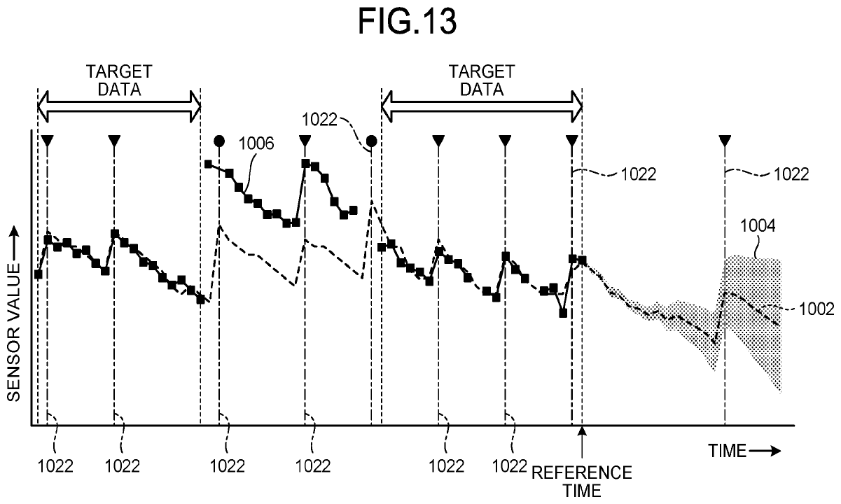

FIG. 13 is a diagram of an example of the estimation image displayed by the display device 24 according to the fourth embodiment. The display device 24 according to the fourth embodiment displays the estimation image illustrated in FIG. 13 on the monitor according to control by the display control module 46 of the estimating device 22.

The estimation image illustrated in FIG. 13 further includes event time information 1022 compared with the estimation image illustrated in FIG. 5. The event time information 1022 is information indicating the occurrence time of the event on the time axis and the kind of the occurring event.

The display device 24 according to the fourth embodiment displays the estimation image described above, thereby further providing the user with the relation between the occurrence of the event and the estimated data.

As described above, the estimation system 20 according to the fourth embodiment removes or selects data in a period determined based on occurrence of an event from the target data and generates the estimation model based on the target data. Consequently, the estimation system 20 according to the fourth embodiment can more accurately estimate the sensor values using the estimation model generated based on the target data from which data having an unusual state is removed, for example.

### Fifth Embodiment

The following describes the estimation system 20 according to a fifth embodiment.

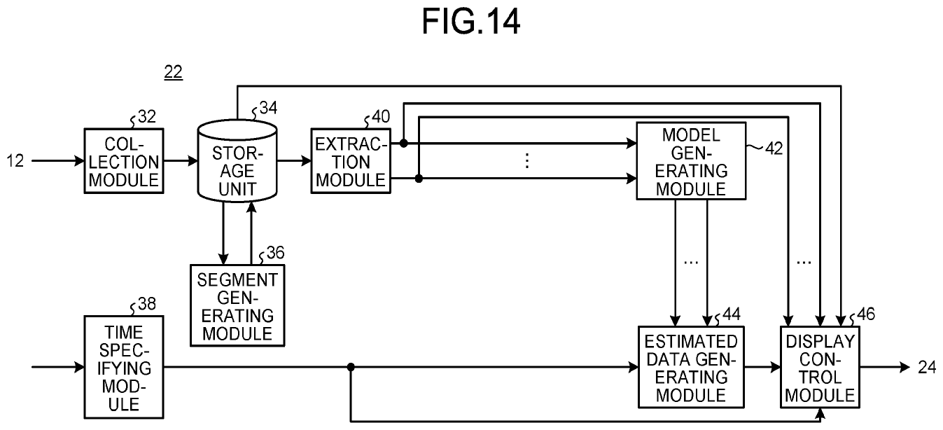

FIG. 14 is a diagram of a functional configuration of the estimating device 22 according to the fifth embodiment. The estimating device 22 according to the fifth embodiment is different from the first embodiment in the processing performed by the extraction module 40, the model generating module 42, and the estimated data generating module 44.

The extraction module 40 extracts pieces of target data each including data having a target operating state from the sensor data for the respective operating states obtained by the segment generating module 36 analyzing the sensor data. If the segment generating module 36 detects N kinds of operating states (N is an integer of 2 or larger) from the sensor data, for example, the extraction module 40 generates N pieces of target data. The N pieces of target data correspond to the respective N kinds of operating states one-to-one.

The model generating module 42 generates estimation models based on the corresponding target data for the respective operating states. If the segment generating module 36 detects N kinds of operating states from the sensor data, for example, the model generating module 42 generates N estimation models. The N estimation models correspond to the respective N kinds of operating states one-to-one.

The estimated data generating module 44 identifies the operating state of the segment including the input reference time. The estimated data generating module 44 selects the estimation model corresponding to the identified operating state from a plurality of estimation models and generates the estimated data by the selected estimation model.

The display control module 46 acquires the target period including the target data corresponding to the operating state of the segment including the reference time from the extraction module 40. The display control module 46 displays the estimation image including the target period on the display device 24.

The estimating device 22 according to the fifth embodiment generates the estimation models for the respective operating states in advance. Consequently, the estimating device 22 need not repeatedly perform generation of the estimation model. If a plurality of reference times are input, the estimating device 22 can efficiently generate the estimated data.

### Sixth Embodiment

The following describes the estimation system 20 according to a sixth embodiment.

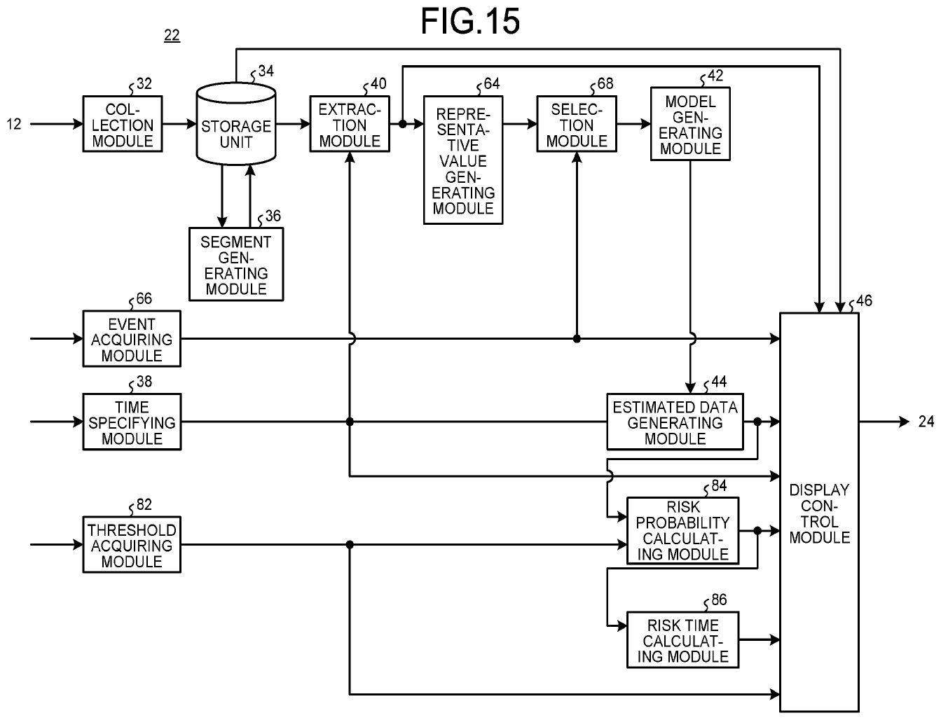

FIG. 15 is a diagram of a functional configuration of the estimating device 22 according to the sixth embodiment. The estimating device 22 according to the sixth embodiment further includes a threshold acquiring module 82, a risk probability calculating module 84, and a risk time calculating module 86 besides the components according to the fourth embodiment. Alternatively, the estimating device 22 according to the sixth embodiment may further include the threshold acquiring module 82, the risk probability calculating module 84, and the risk time calculating module 86 besides the components according to the first, the second, the third, or the fifth embodiment.

The threshold acquiring module 82 acquires a threshold. The threshold is a boundary value between a range of abnormal sensor values (risk range) and a range of normal sensor values (normal range), for example. The threshold acquiring module 82 may acquire the upper limit and the lower limit of the risk range. If the sensor data includes a plurality of sensor values, the threshold acquiring module 82 may acquire the thresholds or the risk ranges for respective two or more sensor values included in the sensor data.

The risk probability calculating module 84 acquires the threshold or the risk range. The risk probability calculating module 84 acquires the estimated data generated by the estimated data generating module 44. The risk probability calculating module 84 calculates time-series data indicating the risk probability that an estimated sensor value is included in the risk range. In this case, the risk probability calculating module 84 calculates the time-series data indicating the risk probability that the sensor value is included in the risk range based on time-series data on the confidence interval and time-series data on the median with a predetermined probability calculated by the estimated data generating module 44.

The risk time calculating module 86 calculates risk time when the estimated sensor value is included in the risk range with a predetermined probability. The risk time calculating module 86, for example, calculates time when the time-series data indicating the risk probability has the predetermined probability as the risk time.

The display control module 46 acquires the threshold or the risk range acquired by the threshold acquiring module 82. The display control module 46 displays the estimation image further including the threshold or the risk range on the display device 24.

The display control module 46 acquires the time-series data having the risk probability that an estimated sensor value is included in the risk range from the risk probability calculating module 84. The display control module 46 displays the estimation image further including the time-series data having the risk probability that the estimated sensor value is included in the risk range on the display device 24.

The display control module 46 acquires the risk time when the estimated sensor value is included in the risk range with a predetermined probability from the risk time calculating module 86. The display control module 46 displays the estimation image further including the risk time when the sensor value is included in the risk range with the predetermined probability on the display device 24.

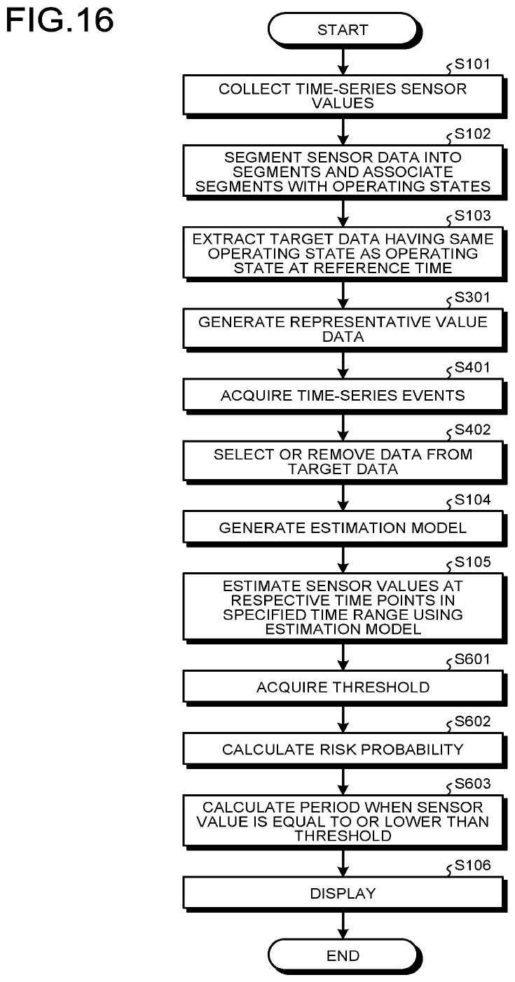

FIG. 16 is a flowchart of a procedure performed by the estimating device 22 according to the sixth embodiment. If the estimating device 22 according to the sixth embodiment receives a start instruction, the estimating device 22 performs processing by the procedure illustrated in FIG. 16.

The processing performed by the estimating device 22 according to the sixth embodiment further includes the processing at S601, S602, and S603 compared with the fourth embodiment. The following describes differences from the fourth embodiment with reference to the procedure illustrated in FIG. 16.

Subsequently to the processing at S105, the estimating device 22 performs the processing at S601. At S601, the threshold acquiring module 82 acquires a threshold indicating a sensor value set by the user, for example. Subsequently, at S602, the risk probability calculating module 84 calculates time-series data indicating the risk probability that an estimated sensor value is included in the risk range. Subsequently, at S603, the risk time calculating module 86 calculates risk time when the sensor value is included in the risk range with a predetermined probability. Subsequently to the processing at S603, the estimating device 22 performs the processing at S106.

At S106, the display control module 46 generates an estimation image further including the threshold, the time-series data indicating the risk probability, and the risk time and displays the estimation image on the display device 24.

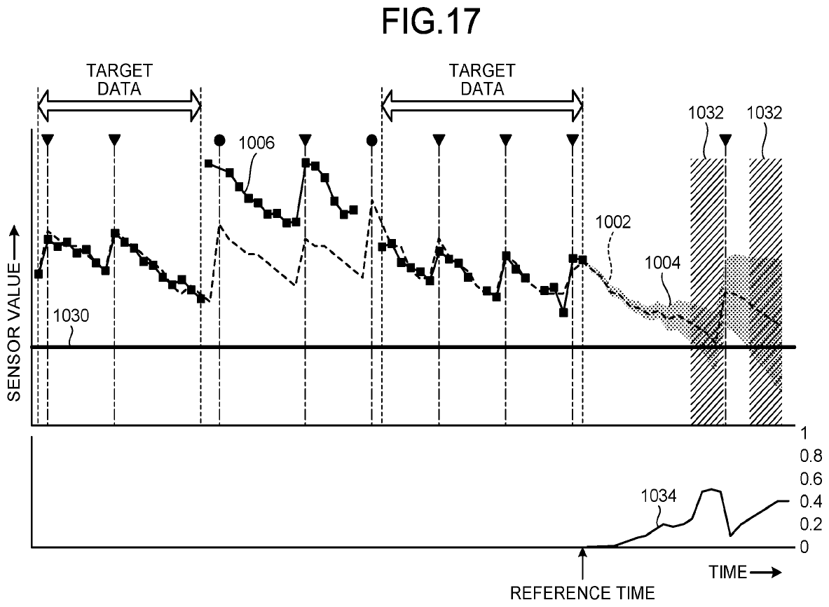

FIG. 17 is a diagram of an example of the estimation image displayed by the display device 24 according to the sixth embodiment. The display device 24 according to the sixth embodiment displays the estimation image illustrated in FIG. 17 on the monitor according to control by the display control module 46 of the estimating device 22.

The estimation image illustrated in FIG. 17 further includes threshold information 1030, risk range information 1032, and a risk probability graph 1034 compared with the estimation image illustrated in FIG. 13.

The threshold information 1030 is a line indicating the lower limit or the upper limit of the risk range of the sensor value. The risk range information 1032 is information indicating the period when the estimated sensor value is included in the risk range with a predetermined probability. The risk range information 1032 is an image of which background color in the estimated value graph 1002 is highlighted, for example.

The estimation image may display the risk range information 1032 indicating the period when the estimated sensor value is included in the risk range for a plurality of probabilities. In this case, the risk range information 1032 is images highlighted in different colors for respective probabilities, for example. The risk range information 1032, for example, includes an image that highlights the period when the estimated sensor value is included in the risk range with a probability of 5% and an image that highlights the period when the estimated sensor value is included in the risk range with a probability of 50%.

The risk probability graph 1034 is a line indicating the risk probability that the estimated sensor value is included in the risk range on the time axis. The time axis of the risk probability graph 1034 is identical with the time axis of the estimated value graph 1002.

The display device 24 according to the sixth embodiment displays the estimation image illustrated in FIG. 17, thereby further providing the user with the probability that the estimated sensor value is included in the risk range.

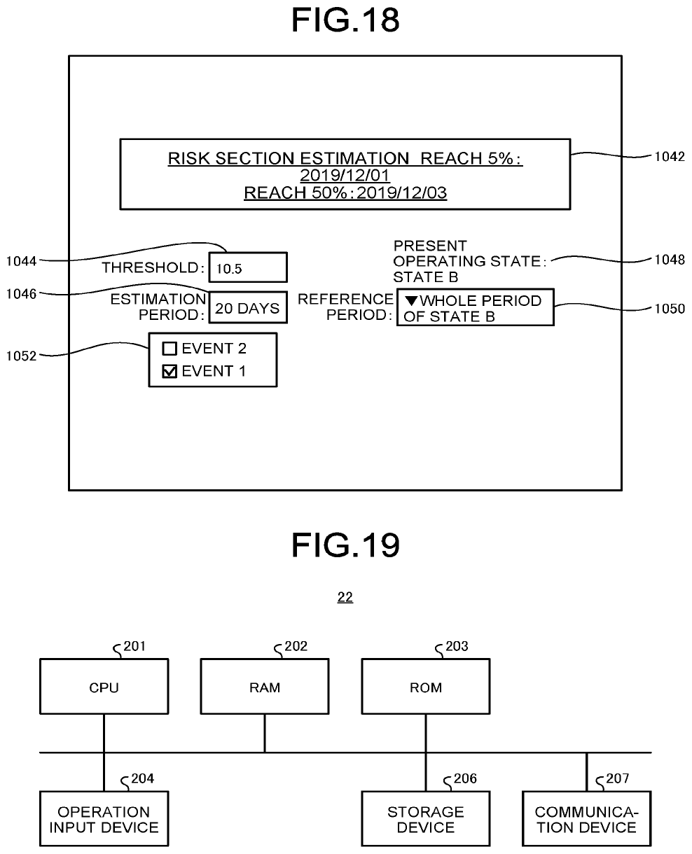

FIG. 18 is a diagram of another example of the estimation image displayed by the display device 24 according to the sixth embodiment. The display device 24 according to the sixth embodiment displays the estimation image illustrated in FIG. 18 besides the estimation image illustrated in FIG. 17. The display device 24 may display the estimation image illustrated in FIG. 17 and the estimation image illustrated in FIG. 18 side by side on the monitor or on respective different pages.

The estimation image illustrated in FIG. 18 includes risk time information 1042, a threshold box 1044, an estimation period box 1046, present operating state information 1048, reference period information 1050, and an event selection box 1052.

The risk time information 1042 includes risk time when the estimated sensor value is included in the risk range with a predetermined probability. The risk time information 1042 may include the risk times for respective times. The risk time information 1042, for example, includes the risk time when the sensor value is included in the risk range with a probability of 5% and the risk time when the sensor value is included in the risk range with a probability of 50%.

The threshold box 1044 is a box to which the user inputs a threshold. The estimation period box 1046 is a box to which the user inputs a specified estimation period. The present operating state information 1048 is information indicating the operating state at the present time. The reference period information 1050 is information indicating the operating state selected as the target data. The event selection box 1052 is a box in which the user selects the kind of the event to be input to the estimation model.

The display device 24 according to the sixth embodiment displays the estimation image illustrated in FIG. 18, thereby further providing the user with the time when the estimated sensor value is included in the risk range.

As described above, the estimation system 20 according to the sixth embodiment provides the user with the probability, the period, and the time when the estimated sensor value is included in the risk range, for example. Consequently, the estimation system 20 according to the sixth embodiment enables the user to set maintenance and the like at an appropriate timing.

### Hardware Configuration

FIG. 19 is a diagram of an example of a hardware configuration of the estimating device 22 according to the embodiments above. The estimating device 22 according to the embodiments above is provided by an information processing device having the hardware configuration illustrated in FIG. 19, for example. The estimating device 22 includes a central processing unit (CPU) 201, a random access memory (RAM) 202, a read only memory (ROM) 203, an operation input device 204, a storage device 206, and a communication device 207. These units are connected to one another by a bus.

The CPU 201 is a processor that performs arithmetic processing, control, and other processing according to computer programs. The CPU 201 performs various kinds of processing in cooperation with the computer programs stored in the ROM 203, the storage device 206, and the like using a predetermined area of the RAM 202 as a work area.

The RAM 202 is a memory, such as a synchronous dynamic random access memory (SDRAM). The RAM 202 functions as a work area for the CPU 201. The ROM 203 is a memory that stores therein computer programs and various kinds of information in a non-rewritable manner.

The operation input device 204 is an input device, such as a mouse and a keyboard. The operation input device 204 receives information input by the user as instruction signals and outputs them to the CPU 201.

The storage device 206 is a device that writes and reads data to and from a semiconductor storage medium, such as a flash memory, or a magnetically or optically recordable storage medium, for example. The storage device 206 writes and reads data to and from the storage medium according to control by the CPU 201. The communication device 207 communicates with external equipment via a network according to control by the CPU 201.

The computer program executed in the estimating device 22 according to the embodiments above includes a collection module, a segment generation module, a time specification module, an extraction module, a model generation module, an estimated data generation module, and a display control module. The computer program is loaded and executed on the RAM 202 by the CPU 201 (processor), thereby causing the information processing device to function as the collection module 32, the segment generating module 36, the time specifying module 38, the extraction module 40, the model generating module 42, the estimated data generating module 44, and the display control module 46. The computer program causes the RAM 202 and the storage device 206 as the storage unit 34. The estimating device 22 may provide at least part of the collection module 32, the segment generating module 36, the time specifying module 38, the extraction module 40, the model generating module 42, the estimated data generating module 44, and the display control module 46 by a hardware circuit (e.g., a semiconductor integrated circuit).

The computer program executed in the estimating device 22 according to the embodiments above is recorded and provided in a computer-readable recording medium, such as a compact disc read only memory (CD-ROM), a flexible disk (FD), a compact disc recordable (CD-R), and a digital versatile disc (DVD), as an installable or executable file.

The computer program executed in the estimating device 22 according to the embodiments above may be stored in a computer connected to a network, such as the Internet, and provided by being downloaded via the network. The computer program executed in the estimating device 22 according to the embodiments above may be provided or distributed via a network, such as the Internet. The computer program executed in the estimating device 22 according to the embodiments above may be embedded and provided in the ROM 203, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a memory; and
one or more processors coupled to the memory and configured to:
generate a plurality of segments segmented by respective operating states of a target device based on time-series sensor data detected by a sensor configured to observe the target device;
extract target data included in a segment having a same operating state as an operating state at certain first time out of the segments; and
generate estimated data estimated to be output from the sensor at specified time different from the first time based on the target data.

2. The device according to claim 1, wherein the one or more processors are configured to analyze the sensor data to generate the segments that are obtained by segmenting the sensor data in a time direction.

3. The device according to claim 1, wherein the first time is present time.

4. The device according to claim 1, wherein the one or more processors are configured to generate the estimated data in a specified time range.

5. The device according to claim 1, wherein
the one or more processors are configured to:
generate an estimation model that outputs the estimated data by input of the specified time based on the target data; and
input the specified time to the estimation model to generate the estimated data.

6. The device according to claim 5, wherein
the one or more processors are configured to:
evaluate estimation accuracy of the estimation model and optimize the generated estimation model;
segment the sensor data into the segments by each of a plurality of methods;
generate a plurality of the estimation models using the segments resulting from segmentation by each of the methods; and
select one estimation model out of the estimation models based on evaluation of the estimation accuracy and use the selected estimation model.

7. The device according to claim 5, wherein
the one or more processors are configured to:
generate a representative value that represents a target predetermined period for each predetermined period in the target data and generate representative value data corresponding to a set of the generated representative values; and
generate the estimation model based on the representative value data.

8. The device according to claim 7, wherein the representative value is a mean or a median of a plurality of sensor values included in the target predetermined period.

9. The device according to claim 1, wherein
the one or more processors are configured to:
acquire event data indicating information on an event occurring for the target device; and
remove or select data in a period determined based on occurrence of the event from among the target data based on the event data.

10. The device according to claim 9, wherein
the one or more processors are configured to:
acquire data indicating that a measured value detected by a measuring device falls out of a predetermined value range as the event data, the measuring device being different from the sensor and measuring a state of the target device; and
remove data in a period when the measured value falls out of the predetermined value range from among the target data based on the event data.

11. The device according to claim 10, wherein
the target device includes a fuel cell, and
the measured value detected by the measuring device includes a voltage value or a current value output from the fuel cell.

12. The device according to claim 5, wherein
the one or more processors are configured to:
extract the target data including data having a target operating state from among the sensor data for each of the operating states obtained by analyzing the sensor data;
generate the estimation model based on the corresponding target data for each of the operating states; and
select the estimation model corresponding to the operating state of the segment including the input first time and generate the estimated data by the selected estimation model.

13. An information processing method executed by an information processing device, the information processing method causing the information processing device to perform:
generating a plurality of segments segmented by respective operating states of a target device based on time-series sensor data detected by a sensor configured to observe the target device;
extracting target data included in a segment having a same operating state as an operating state at certain first time out of the segments; and
generating estimated data estimated to be output from the sensor at specified time different from the first time based on the target data.

14. A computer program product having a computer readable medium including programmed instructions, the instructions causing a computer to execute:
generating a plurality of segments segmented by respective operating states of a target device based on time-series sensor data detected by a sensor configured to observe the target device;
extracting target data included in a segment having a same operating state as an operating state at certain first time out of the segments; and
generating estimated data estimated to be output from the sensor at specified time different from the first time based on the target data.

15. An information processing device configured to cause an estimation image to be displayed, the estimation image comprising:
an estimated value graph indicating estimated data estimated to be output from a sensor that observes a target device, on a time axis;
an actual value graph indicating time-series sensor data observed by the sensor on the time axis;
a boundary time information indicating boundary time of a segment on the time axis when the sensor data is segmented into a plurality of segments corresponding to respective operating states of the target device; and
target period information indicating a target period including target data having a same operating state as an operating state of a segment including certain first time in the sensor data on the time axis.

16. The device according to claim 15, wherein the estimation image further comprises estimation interval information indicating a confidence interval that indicates a range of the estimated data estimated to be output with a predetermined probability

17. The device according to claim 16, wherein the estimation image further comprises risk probability information indicating risk probability that the estimated data is included in a predetermined risk range.

18. The device according to claim 17, wherein the estimation image further comprises risk time information indicating risk time when the estimated data is included in the risk range with a predetermined probability.
